(19) United States
(12) Patent Application Publication
(10) Pub. No.: US 2012/0287636 A1
(43) Pub. Date: Nov. 15, 2012

(54) Light emitting diode lamp capability of increasing angle of illumination

(76) Inventor: Hsing Chen, Kukou Township (TW)

(21) Appl. No.: 13/106,830

(22) Filed: May 12, 2011

(51) Int. Cl. F21V 29/00; F21V 21/00

(52) U.S. Cl. 362/249.02

(57) ABSTRACT

A light emitting diode lamp capability of increasing angle of illumination includes a heat sink base, a polygonal solid LED illumination module and transparent cover. The heat sink base is formed with an LED illumination module. mounted region. The polygonal solid LED illumination module is located on the LED illumination module mounted region of the heat sink base, the polygonal solid LED illumination module has a solid print circuit board and a plurality or LED units the solid print circuit board are formed with a central top plane and at least three lateral plane sets, which are bended from the central top plane, the central top plane of the solid print circuit board is mounted on the LED illumination mounted region of the heat sink base, the LED units arc arranged on the central top plane and the lateral plane sets individually. The transparent cover is mounted at the heat sink base for cover the polygonal solid LED illumination module.

### BACKGROUND OF THE INVENTION

1. Field of the Invention

The invention to a light emitting diode lamp capability of increasing angle of illumination, and in particular to a polygonal solid LED illumination module has a solid printed circuit board, which may bend to a plurality of lateral plane sets, The LED units are arranged at the lateral plane sets to increase angle of illumination.

2. Description of the Related Art

In general, the light emitting diode uses unusual widespread, it has the life to be long and to use the electric quantity low merit, therefore, its may substitute for the traditional lamps and lanterns, like the computer uses back source and street light.

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness. These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness,

Please refers to FIG. 1, conventional LED lamp includes a heat sink base 10, A LED illumination module 12 and a transparent cover 14. The heat sink base 10 includes A LED illumination module mounted region16 and a plurality of heat sinks 18. The LED illumination module 12 is mounted on the LED illumination module mounted region16 of the heat sink base16, the LED illumination module 12 has a printed circuit board 20 and a plurality of LED 22 located on the printed circuit board 20. The transparent cover 14 is arranged at the heat sink base to cover the LED illumination module 12

The foregoing lamp has as following shortcoming:

The printed circuit board 20 is a flat surface, The LED are mounted on the printed circuit board 20, therefore, the LED are illuminated toward the upper surface of the printed circuit board 22, so that the illumination is only 180 degree to not obtain larger Illumination angle. Furthermore, U.S. energy Star specified that LED lamp replaces conventional lamp, the illumination angle from the LED illumination module must larger than 270 degree.

### SUMMARY OF THE INVENTION

To achieve the above-mentioned objective, the invention includes a heat sink base, a polygonal solid LED illumination module and a transparent cover. The heat sink base is formed with an LED illumination module mounted region. The polygonal solid LED illumination module is located on the LED illumination module mounted region of the heat sink base. The polygonal solid LED illumination module has a solid print circuit board and a plurality of LED units, the solid print circuit board are formed with a central top plane and at least three lateral plane sets, which are bended from the central top plane, the central top plane of the solid print circuit board is mounted on the LED illumination mounted region of the heat sink base. The LED units are arranged on the central top plane and the lateral plane sets individually. The transparent cover is mounted at the heat sink base to cover the polygonal solid LED illumination module.

Therefore, the LED units are arranged on the central plane and lateral plane of the solid print circuit board to increase illumination angle to conform the U.S. energy Star specified.

### BRIEF DESCRIPTION OF THE DRAWINGS

FIG. 1 is a cross-sectional view showing a conventional light emitting diode lamp.

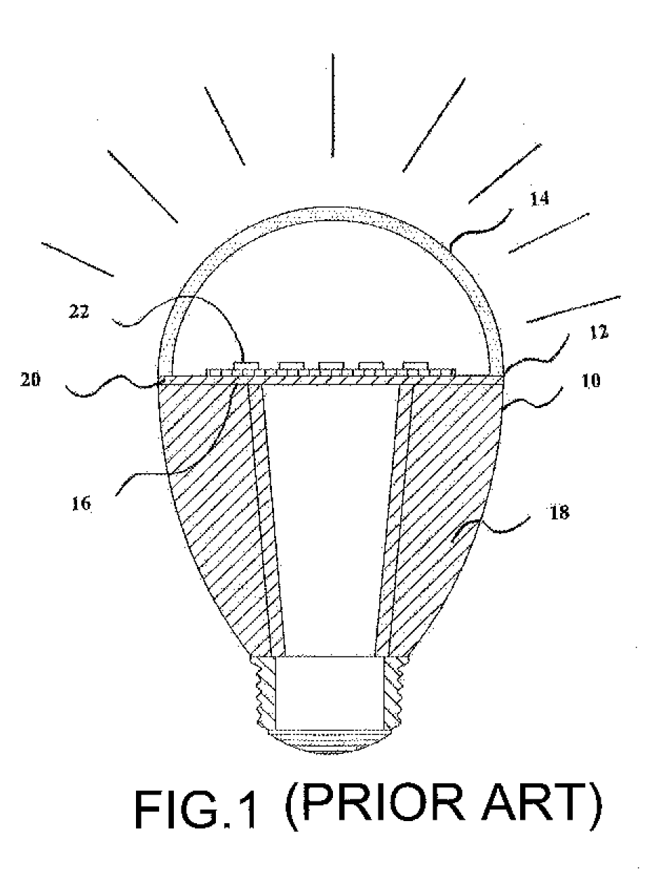

FIG. 2 is an exploded view showing a light emitting diode lamp capability of increasing angle of illumination of the present invention.

FIG. 3 is a cross-sectional view of the FIG. 2.

FIG. 4 is a first schematic illustration showing a flat surface of solid print circuit board of the present invention.

FIG. 5 is a second schematic illustration showing a fiat surface of solid print circuit board of the present invention.

FIG. 6 is a third schematic illustration showing a flat surface of solid print circuit board of the present invention.

FIG. 7 is a solid diagram of the FIG. 6.

FIG. 8 is a fourth schematic illustration showing a flat surface of solid print circuit board of the present invention.

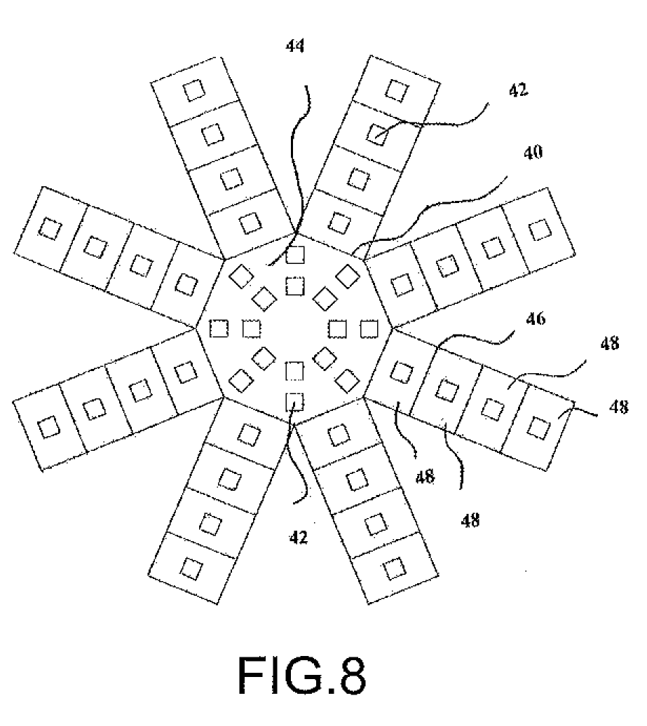

FIG. 9 is a solid diagram of the FIG 8.

### DETAILED DESCRIPTION OF THE INVENTION

Reference will now be made in detail to a preferred embodiment of the present invention.

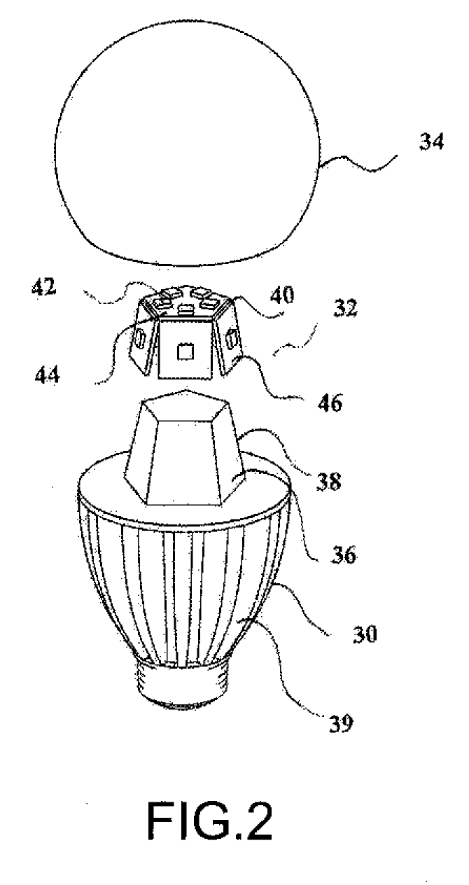

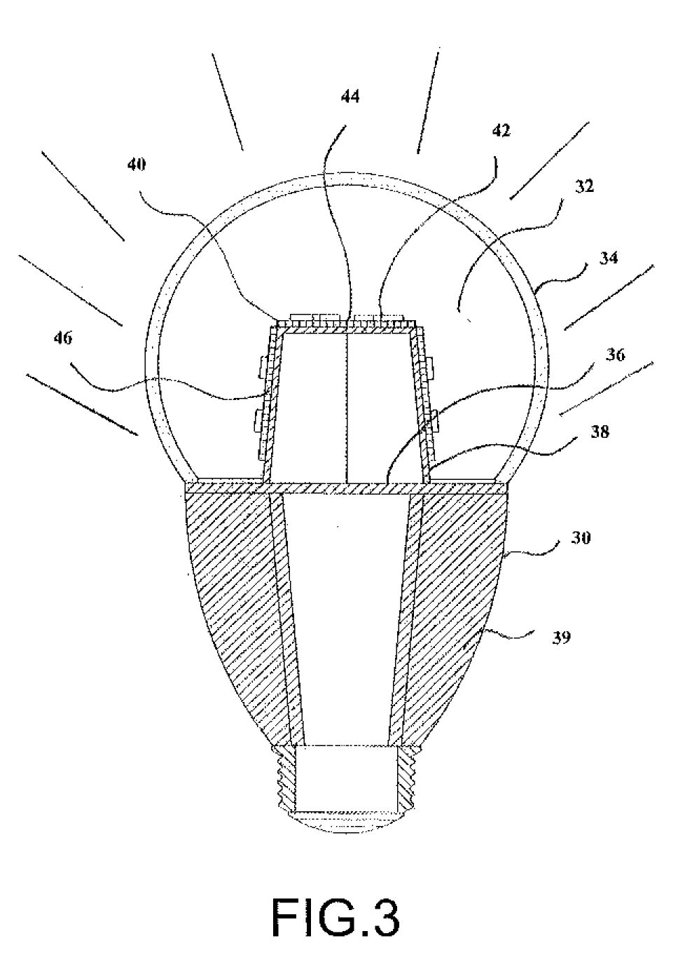

Referring to FIG. 2 and FIG. 3, a light emitting diode lamp capability of increasing angle of illumination in accordance with the present invention includes a heat sink base 30, a polygonal solid LED illumination module 32 and a transparent cover 34. Wherein

The heat sink base 30 is formed with an LED illumination module mounted region 36, a fixed base 38 located on the LED illumination module mounted region 36 and a plurality of heat sinks 39 located on the periphery of the heat sink base 30.

The polygonal solid LED illumination module 32 is located on the LED illumination module mounted region 36 of the heat sink base 30 and includes a solid print circuit board 40 and a plurality of LED units 42, the solid print circuit board 40 is formed with a central top plane 44 and five lateral plane sets 46, which are bended from the central top plane 44, the central top plane 44 of the solid print circuit board 40 is mounted on the fixed base 38 of the heat sink base 30, the LED units 42 are arranged on the central top plane 44 and the lateral plane sets 46 individually.

The transparent cover 34 is mounted at the heat sink base 30 to cover the polygonal solid LED illumination module 32.

Therefore, the LED units 42 are arranged on the central top plane 44 and the central plane 46 of the solid print circuit board 40, so that the present invention may increase the angle of illumination.

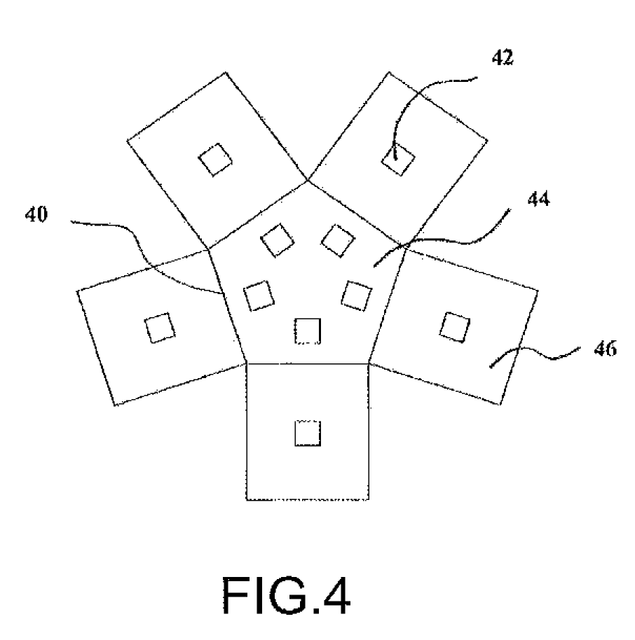

Please refer to FIG. 4, wherein the solid print circuit board 40 includes a central top plane 44 and five lateral plane sets 46, the LED units 42 are arranged on the central top plane 44 and five lateral plane sets 46.

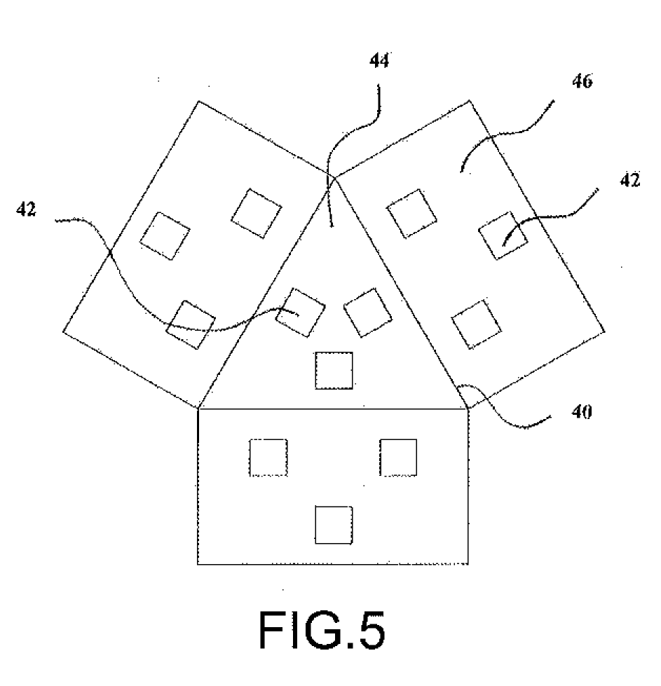

Please refer to FIG. 5, wherein the solid print circuit board 40 includes a central top plane 44 and three lateral plane sets 46, the LED units 42 are arranged on the central top plane 44 and three lateral plane sets 46.

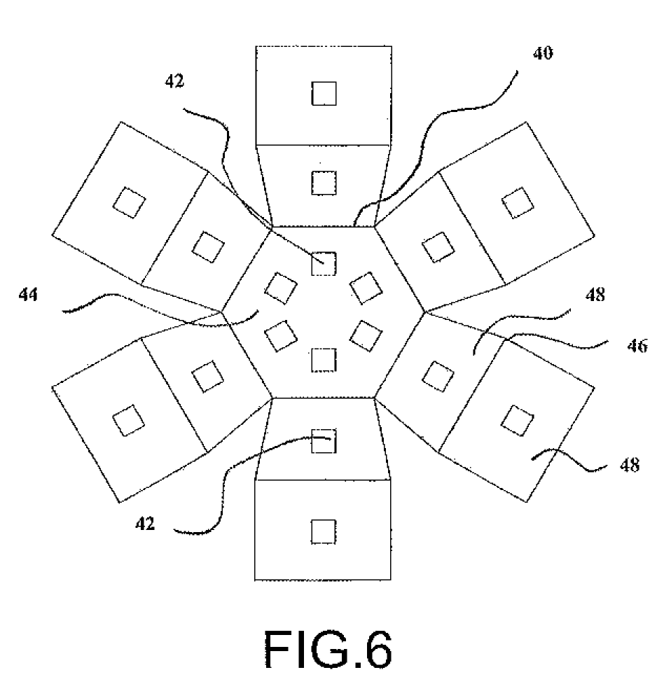

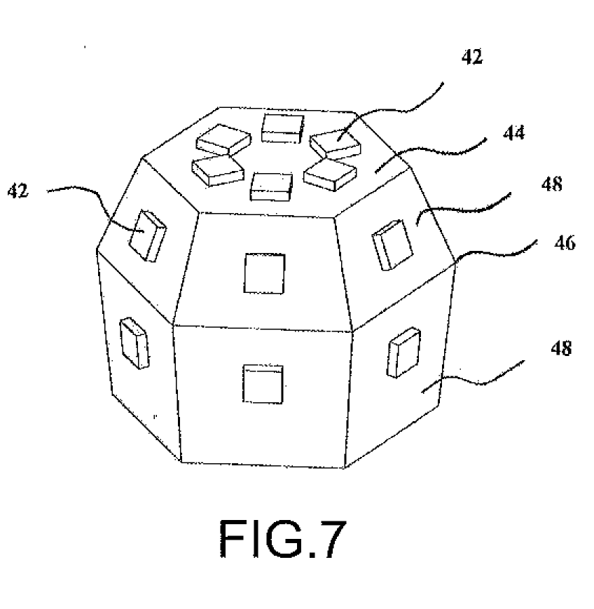

Please refer to FIG. 6 and FIG. 7, wherein the solid print circuit board 40 includes a central top plane 44 and six lateral plane sets 46, each of the lateral plane set 46 has two lateral boards 48 located in different of flat surface, the LED units 42 are arranged on the central plane 44 and the lateral boards 48.

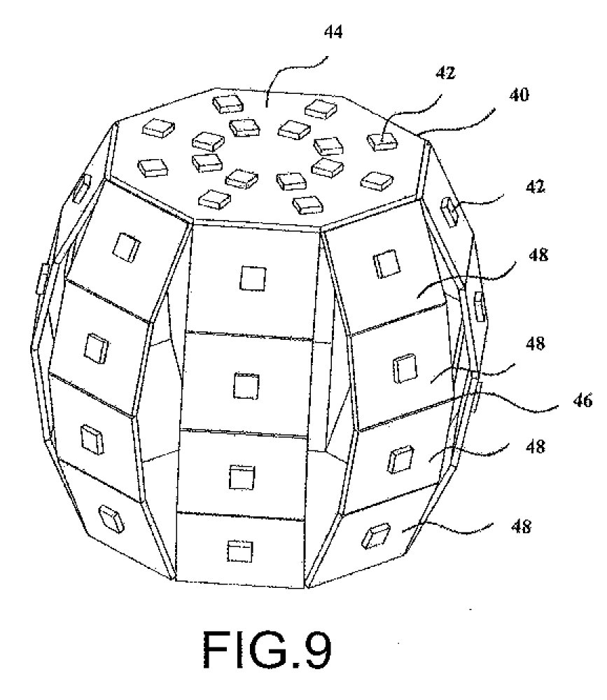

Please refer to FIG. 9 and FIG. 9, wherein the solid print circuit board 40 includes a central top plane 44 and eight lateral plane sets 46, each of the lateral plane set 46 has four lateral boards 48 located in different of flat surface, the LED units 42 are arranged on the central plane 44 and the lateral boards 48.

While the invention has been described by the way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A light emitting diode lamp capability of increasing angle o comprising:
a heat sink base with an LED illumination module mounted region;
a polygonal solid LED illumination module located on the LED illumination module mounted region of the heat sink base, the polygonal solid LED illumination module having a solid print circuit board and a plurality of LED units, the solid print circuit hoard formed with a central top plane and at least three lateral plane sets, which are bended from the central top plane, the central top plane of the solid print circuit board mounted on the LED illumination mounted region of the heat sink base, the LED units arranged on the central top plane and the lateral plane sets individually; and
a transparent cover mounted at the heat sink base to cover the polygonal solid LED illumination module.

2. The light emitting diode lamp capability of increasing angle of illumination according to claim 1, wherein the solid print circuit board includes a central top plane and five lateral plane sets, which are bended from the central top plane.

3. The light emitting diode lamp capability of increasing angle of illumination according to claim 1, wherein the lateral plane set of polygonal solid LED illumination module includes at least two lateral boards located in different of flat surface, the LED units are arranged at the lateral board individually.

4. The light emitting diode lamp capability of increasing angle of illumination according to claim 3, wherein the lateral plane set of the polygonal solid LED illumination module includes four lateral boards located in different of flat surface, the LED units are arranged at the four lateral boards individually.

5. The light emitting diode lamp capability of increasing angle of illumination according to claim 1, wherein the lateral plane sets of the polygonal solid LED illumination module includes at least two lateral boards located in different of flat surface.

6. The light emitting diode lamp capability of increasing angle of illumination according to claim 1, wherein the lateral plane sets of the polygonal solid LED illumination module includes four lateral boards located in different of flat surface.

7. The light emitting diode lamp capability of increasing angle of illumination according to claim 1, further comprising a fixed body arranged at the LED illumination module mounted region of the heat sink base.
